(19) United States
(12) Patent Application Publication
(10) Pub. No.: US 2025/0313234 A1
(43) Pub. Date: Oct. 9, 2025

(54) METHOD AND SYSTEM TO REPLICATE DRIVER PERSONALITIES

(71) Applicant: GM Global Technology Operations LLC, Detroit, MI (US)

(72) Inventors: Spencer Taft, Victoria (CA); Russell A. Patenaude, Macomb Township, MI (US); Ryan M. Edwards, Shelby Township, MI (US)

(73) Assignee: GM Global Technology Operations LLC, Detroit, MI (US)

(21) Appl. No.: 18/628,605

(22) Filed: Apr. 5, 2024

(51) Int. Cl. B60W 60/00; B60W 40/09; B60W 50/00; B60W 50/14

(52) U.S. Cl. CPC B60W 60/0015; B60W 40/09; B60W 50/14; B60W 2050/0052; B60W 2050/0083; B60W 2050/146; B60W 2540/215; B60W 2540/30

(57) ABSTRACT

A method includes receiving a request to initialize a driver profile of a target driver for a vehicle, the driver profile including a plurality of filters each configured to approximate a driving style of the target driver. The method also includes initializing the driver profile of the target driver, obtaining sensor data indicating a context of the vehicle that triggers a vehicle decision to perform a vehicle action, and identifying a filter of the plurality of filters that corresponds to the vehicle action. The method further includes applying the filter to the vehicle action to generate an adjusted action that approximates a driving action of the target driver, applying a safety filter to the adjusted action to generate a safety adjusted action, and instructing the vehicle to perform the vehicle decision including the safety adjusted action.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a system and method of generating driver profiles and implementing the generated driver profiles in additional routes. In particular, a driver of an autonomous vehicle may find that the off-the-shelf driving personality of the vehicle does not align with the driving personality of the driver. For example, while the driving personality of the vehicle may implement a close following distance with other vehicles, the driving personality of the driver may be more cautious and require a greater following distance to other vehicles. Moreover, when visiting a different city, the autonomous vehicle may benefit from modifications approximating a local driver personality. In additional instances, capturing and replicating a driving personality may provide the opportunity to observe and/or evaluate the driver.

### SUMMARY

One aspect of the disclosure provides a computer-implemented method for onset zone detection using coherent focusing summation over multiple geometric positions that when executed on data processing hardware causes the data processing hardware to perform operations that include receiving a request to initialize a driver profile of a target driver for a vehicle, the driver profile including a plurality of filters, each filter of the plurality of filters configured to approximate a driving action of the target driver, and initializing the driver profile of the target driver. The operations also include obtaining sensor data indicating a context of the vehicle, the context triggering a vehicle decision to perform a vehicle action, and based on the vehicle decision to perform the vehicle action, identifying a filter of the plurality of filters of the driver profile that corresponds to the vehicle action. The operations further include applying the filter of the driver profile to the action to generate an adjusted action that approximates the driving style of the target driver, applying a safety filter to the adjusted action to generate a safety adjusted action, and instructing the vehicle to perform the vehicle decision including the safety adjusted action.

Implementations of the disclosure may include one or more of the following optional features. In some implementations, the driver profile is stored in a corpus of driver profiles. In these implementations, the corpus of driver profiles may include one or more aggregate driver profiles each approximating a demographic driving style. Additionally or alternatively, these implementations include receiving driving data, the driving data including a plurality of driving actions, for each driving action of the plurality of driving actions, deriving a filter from the driving action and associating one or more of vehicle parameters, vehicle environment, or vehicle positioning with the derived filter, generating a new driver profile including the plurality of derived filters, and storing the new driver profile in the corpus of driver profiles. Here, the plurality of driving actions may include one or more of steering, throttle, or braking.

In some examples, each filter of the plurality of filters is associated with a set of driving actions of the target driver. In some implementations, identifying the filter of the plurality of filters of the driver profile that corresponds to the action is based on a driver context associated with the filter. Here, the driver context corresponds to the context of the vehicle. In some examples, applying the safety filter to the adjusted action to generate the safety adjusted action includes determining that the adjusted action that approximates the driving style of the target driver exceeds a safe driving threshold, and generating, for output to a passenger of the vehicle, a notification indicating that that the driving style of the target driver exceeds the safe driving threshold. In some implementations, applying the safety filter to the adjusted action to generate the safety adjusted action includes determining that the adjusted action that approximates the driving style of the target driver does not exceed a safe driving threshold, and applying a null filter to the adjusted action. In some examples, the operations further include obtaining additional sensor data indicating a subsequent context of the vehicle, the subsequent context triggering a subsequent vehicle decision to perform an additional vehicle action, determining that the plurality of filters of the driver profile do not include a filter that corresponds to the subsequent vehicle action, and instructing the vehicle to perform the subsequent vehicle decision without modifying the subsequent vehicle action.

Another aspect of the disclosure provides a system for onset zone detection using coherent focusing summation over multiple geometric positions that includes data processing hardware and memory hardware in communication with the data processing hardware. The memory hardware stores instructions that when executed by the data processing hardware cause the data processing hardware to perform operations that include receiving a request to initialize a driver profile of a target driver for a vehicle, the driver profile including a plurality of filters, each filter of the plurality of filters configured to approximate a driving action of the target driver, and initializing the driver profile of the target driver. The operations also include obtaining sensor data indicating a context of the vehicle, the context triggering a vehicle decision to perform a vehicle action, and based on the vehicle decision to perform the vehicle action, identifying a filter of the plurality of filters of the driver profile that corresponds to the vehicle action. The operations further include applying the filter of the driver profile to the action to generate an adjusted action that approximates the driving style of the target driver, applying a safety filter to the adjusted action to generate a safety adjusted action, and instructing the vehicle to perform the vehicle decision including the safety adjusted action.

This aspect may include one or more of the following optional features. In some implementations, the driver profile is stored in a corpus of driver profiles. In these implementations, the corpus of driver profiles may include one or more aggregate driver profiles each approximating a demographic driving style. Additionally or alternatively, these implementations include receiving driving data, the driving data including a plurality of driving actions, for each driving action of the plurality of driving actions, deriving a filter from the driving action and associating one or more of vehicle parameters, vehicle environment, or vehicle positioning with the derived filter, generating a new driver profile including the plurality of derived filters, and storing the new driver profile in the corpus of driver profiles. Here, the plurality of driving actions may include one or more of steering, throttle, or braking.

In some examples, each filter of the plurality of filters is associated with a set of driving actions of the target driver. In some implementations, identifying the filter of the plurality of filters of the driver profile that corresponds to the action is based on a driver context associated with the filter. Here, the driver context corresponds to the context of the vehicle. In some examples, applying the safety filter to the adjusted action to generate the safety adjusted action includes determining that the adjusted action that approximates the driving style of the target driver exceeds a safe driving threshold, and generating, for output to a passenger of the vehicle, a notification indicating that that the driving style of the target driver exceeds the safe driving threshold. In some implementations, applying the safety filter to the adjusted action to generate the safety adjusted action includes determining that the adjusted action that approximates the driving style of the target driver does not exceed a safe driving threshold, and applying a null filter to the adjusted action. In some examples, the operations further include obtaining additional sensor data indicating a subsequent context of the vehicle, the subsequent context triggering a subsequent vehicle decision to perform an additional vehicle action, determining that the plurality of filters of the driver profile does not include a filter that corresponds to the subsequent vehicle action, and instructing the vehicle to perform the subsequent vehicle decision without modifying the subsequent vehicle action.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a schematic view of an example system for replicating driver personalities.

FIG. 2 is a schematic view of example components of the system of FIG. 1.

FIG. 3 is a schematic view of example components of the system of FIG. 1.

FIGS. 4A-4C are schematic views of a vehicle replicating a driver personality in an example environment.

FIG. 5 is a flowchart of an example arrangement of operations for a method of replicating driver personalities.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

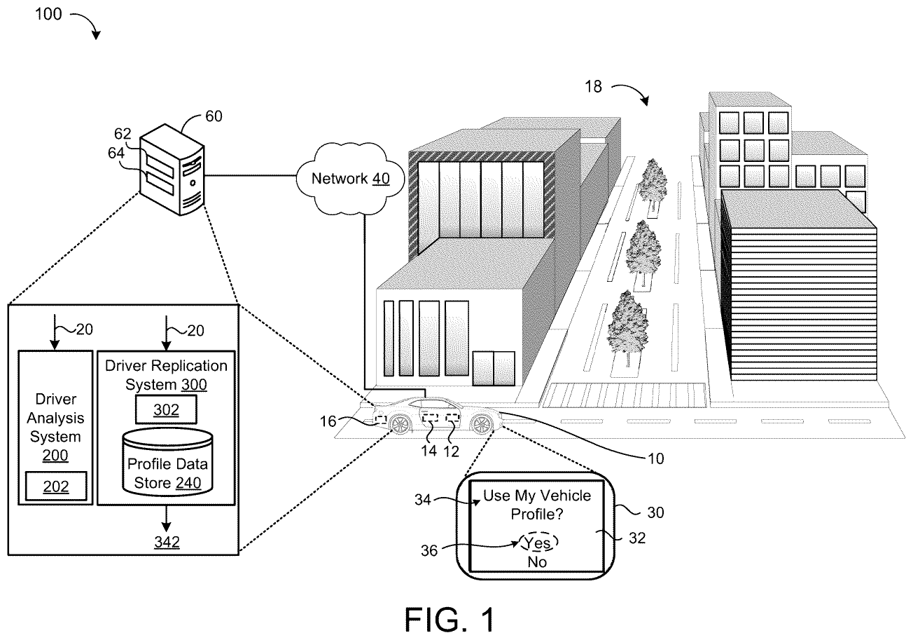

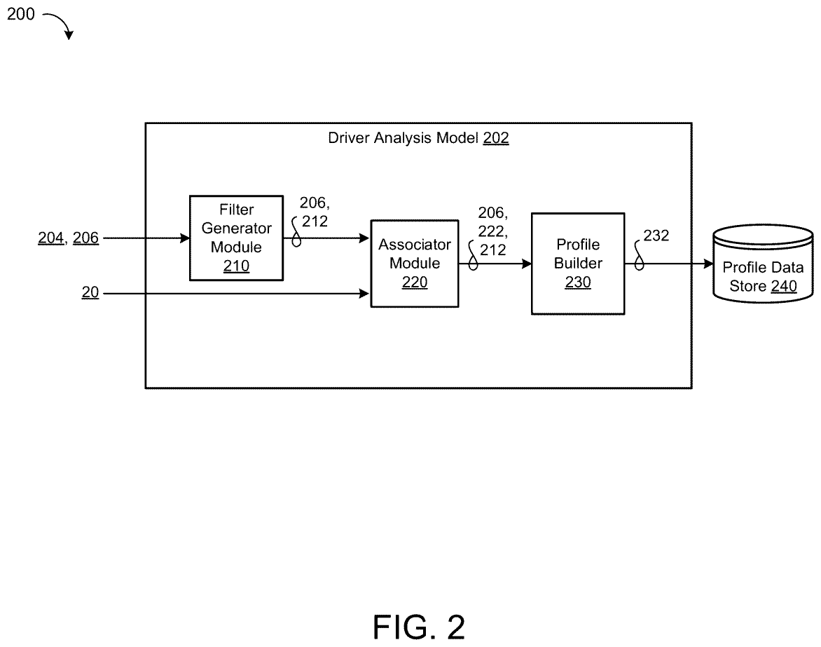

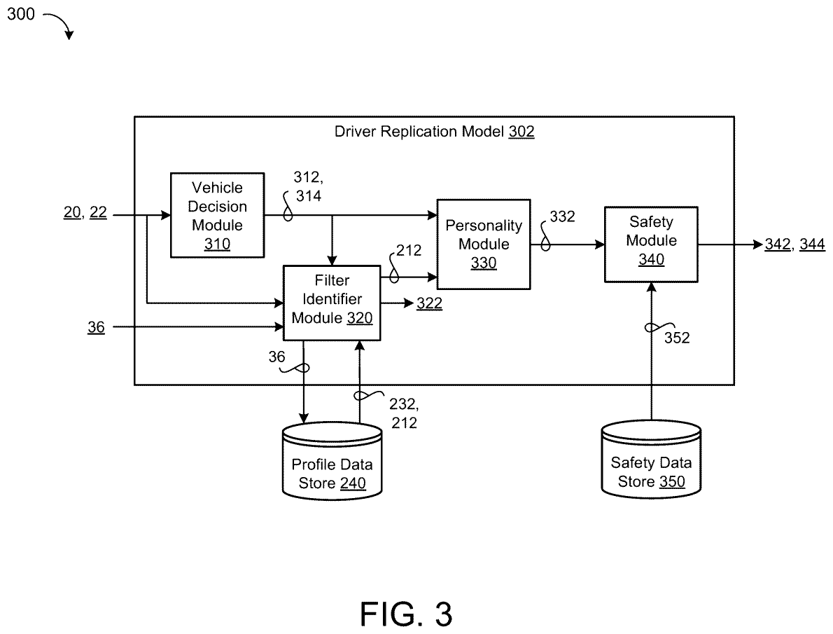

Referring to FIG. 1, in some implementations, a system 100 includes a vehicle 10 and/or a remote system 60 in communication with the vehicle 10 via a network 40. The vehicle 10 and/or the remote system 60 execute a driver analysis system 200 (FIG. 2) and a driver replication system 300 (FIG. 3) configured to capture a driver's driving style and model the driver's driving style to apply it to future drives. Briefly, and as described in further detail below, the driver analysis system 200 receives driving data 204 including a plurality of driving actions 206 and generates a new driver profile 232 that may be used by the driver replication system 300 to either replay a previous drive from the new driver profile 232 or use the driver profile 232 to emulate a driving style of the new driver profile 232. In other words, the driver analysis system 200 analyzes a driver's behavior such that the driver replication system 300 may replicate the driver's behavior in subsequent drives.

The vehicle 10 may include an autonomous vehicle (e.g., SAE levels 3-5) that includes data processing hardware 12 and memory hardware 14 storing instructions that when executed on the data processing hardware 12 cause the data processing hardware 12 to perform operations. As shown, the vehicle 10 is in communication with the remote system 60 via the network 40. The remote system 60 (e.g., server, cloud computing environment) also includes data processing hardware 62 and memory hardware 64 storing instructions that when executed on the data processing hardware 62 cause the data processing hardware 62 to perform operations. In some examples, execution of the driver analysis system 200 and the driver replication system 300 is shared across the vehicle 10 and the remote system 60. Additionally, the vehicle 10 includes a sensor system 16 configured to capture sensor data 20 within the vehicle 10 and within an environment 18 of the vehicle 10. The vehicle 10 may continuously, or at least during periodic intervals, receive the sensor data 20 captured by the sensor system 16 to determine the context 24 of the vehicle 10. Some examples of sensor data 20 include vehicle parameters, vehicle environment, and vehicle positioning. For example, the vehicle parameters may include current speed, current driver inputs, distance to other vehicles, vehicle velocity relative to other vehicles, speed into/out of turns, and reaction time. The vehicle environment may include red lights, pedestrian proximity, construction, crosswalks, starting from a stop, merging, turning into a street, and parking. The vehicle positioning may include the start of braking distance, the end of braking distance, the following distance to vehicles, the inching out distance, and the position in the lane. The sensor data 20 may further include image and/or radar data indicating where the driver focuses, how the driver sits, where the driver's hands are positioned, etc.

In some implementations, the vehicle 10 may include or be in communication with a user interface 30 including a graphical user interface (GUI) 32. The GUI 32 may facilitate a user of the user interface 30 selecting a driver profile 232 to use during a drive by allowing the user to select a driver profile 232 using the GUI 32. As shown in FIG. 1, the GUI 32 renders/displays a graphical element representing a prompt for the user “Use My Vehicle Profile?” and the graphical elements for the user to select “Yes” or “No” as a selectable option 36 that, when selected, authorizes/requests the vehicle 10 to initialize the selected driver profile 232. As used herein, the GUI 32 may receive user input indications via any one of touch, speech, gesture, gaze, and/or an input device (e.g., mouse or stylus) for interacting with the assistant application 140.

Referring to FIG. 2, the driver analysis system 200 is configured to generate the driver profiles 232 and includes a filter generator module 210, an associator module 220, and a profile builder 230. Additionally, the driver analysis system 200 has access to a profile data store 240 that resides on the memory hardware 14 of the vehicle 10 and/or the memory hardware 64 of the remote system 60. The profile data store 350 may include a corpus of driver profiles 232 that the driver replication system 300 (FIG. 3) may access when initializing a requested driver profile 232. The filter generator module 210 is configured to receive, as input, driving data 204 including a plurality of driving actions 206. For example, the driving data 204 may include the sensor data 20 captured by the sensor system 16 and/or any historical driving data from previous routes. The plurality of driving actions 206 may include at least one of steering, throttle, and braking traces of the vehicle 10.

The filter generator module 210 receives the driving actions 206 and, for each driving action 206 of the plurality of driving actions 206, the filter generator module 210 derives a filter 212 from the driving action 206. For example, the filter generator module 210 calculates the time derivative of an average of the driving action 206 and stores the calculated time derivative as a finite impulse response (FIR) filter 212. Here, the FIR filter 212 represents the driver's driving behavior in the driving data 204. Notably, each filter 212 may be averaged over multiple inputs to the driver profile 232 to increase the accuracy and length of the filter 212. In some implementations, rather than generating a FIR filter, the filter generator module 210 directly records the driving actions 206 as a trace filter 212 to be replayed in a later drive. For example, when a driver wants to replicate a drive from start to finish, the vehicle 10 may initialize the trace filter 212 including the direct recording of the driving actions 206.

With continued reference to FIG. 2, the associator module 220 may receive the driving actions 206 and the respective filters 212 that represent the driving actions 206. Additionally, the associator module 220 may receive, as input, the sensor data 20 captured by the sensor system 16, the sensor data 20 including one or more of the vehicle parameters, the vehicle environment, or the vehicle positioning, and identify a driver context 222 associated with each of the respective driving actions 206. In other words, the associator module 220 may, for each driving action 206, ascertain the driver context 222 of the vehicle 10 at the time of the driving action 206 based on the sensor data 20 of the vehicle 10. For example, the associator module 220 may receive the sensor data 20 indicating a deceleration driving action 206 of the vehicle 10 and a visible construction zone, and identify that the driver context 222 that the driver personality includes slowing down in a construction zone. Thereafter, the associator module 220 associates the driver context 222 of a construction zone with the driving action 206 of deceleration and the filter 212 associated with the driving action 206 of deceleration. Thereafter, the profile builder 230 may compile the associated driving actions 206, respective filters 212, and driver contexts 222 into a driver profile 232 to generate a new driver profile 232 including the respective filters 212 and associated driver contexts 222 and driving actions 206. For example, the profile builder 230 may build the driver profile 232 as a dataset of the associated driving actions 206, the respective filters 212, and the driver contexts 222 and tag the associated driving actions 206, the respective filters 212, and the driver contexts 222 with a user identifier that may be used by the driver replication model 300 to search for a particular driver profile 232. Here, each filter 212 may be associated with a set of one or more of the driving actions 206.

Referring to FIGS. 1 and 3, the driver replication system 300 executes a driver replication model 302 configured to apply a driving style of a target driver (e.g., a driver profile 232) to a current drive of the vehicle 10. The driver replication model 302 includes a vehicle decision module 310, a filter identifier module 320, a personality module 330, and a safety module 340. The driver replication model 302 may have access to the profile data store 350 and a safety data store 350 that resides on the memory hardware 14 of the vehicle 10 and/or the memory hardware 64 of the remote system 60. As noted, the profile data store 350 includes a corpus of driver profiles 232, where each driver profile 232 in the corpus of driver profiles 232, when applied to a current drive, modifies the actions of the vehicle 10. Each driver profile 232 may correspond to a driver that has opted into the driver analysis system 200 to provide driving data. In some examples, the corpus of driver profiles 232 includes one or more aggregate drive profiles, where each aggregate driver profile approximates a demographic driving style. In these examples, the demographic may include a regional demographic, an age demographic, etc., where the data for each individual driver profile 232 is anonymized. In some implementations, the corpus of driver profiles 232 may include one or more celebrity driver profiles 232 that passengers of the vehicle 10 may select to experience the driving style of the celebrity. Optionally, a passenger of the vehicle 10 may select their own driver profile 232 to experience their driving style as a passenger of the vehicle 10, or the driver profile 232 of a household member (e.g., a teenage driver) of the passenger (e.g., a parent) to evaluate the style of the driver profile 232.

As described in FIG. 1, the vehicle 10 may receive the request (i.e., the selectable option 36) to initialize a driver profile 232 of a target driver for the vehicle 10. Here, the driver profile 232 of the target driver includes a plurality of filters 212, where each filter 212 of the plurality of filters 212 is configured to approximate a driving style of the target driver. When the vehicle 10 receives the requested selectable option 36, it initializes the driver profile 232 of the target driver.

The vehicle decision module 310 generally includes a standardized autonomous vehicle decision model configured to operate (either partially or fully) the vehicle 10. The vehicle decision module 310 receives, as input, the sensor data 20. Here, the sensor data 20 may indicate a context 22 of the vehicle 10 that causes the vehicle decision module 310 to trigger a vehicle decision 312 to perform a vehicle action 314. For example, the vehicle action 314 may include one or more of steering, throttle, or braking, where sensor data 20 indicating a context 22 that a pedestrian is crossing the road may cause the vehicle decision module 310 to trigger a vehicle decision 312 to perform the vehicle action 314 of braking.

The filter identifier module 320 additionally receives, as input, the sensor data 20 indicating the context 22 of the vehicle 10, and identifies a filter 212 of the plurality of filters 212 of the driver profile 232 that corresponds to the action 314. The filter identifier module 320 may identify a driver context 222 of the initialized driver profile 232 that corresponds to the context 22 of the vehicle 10, and, based on the driver context 222 corresponding to the context 22 of the vehicle 10, identify the filter 212 associated with the identified driver context 222. In other words, the filter identifier module 320 compares the context 22 of the vehicle 10 to the driver contexts 222 in the driver profile 232 and, when the filter identifier module 320 does not find a match, it may notify the user that the driver profile 232 is not being used/replicated. Conversely, when the filter identifier module 320 finds a match between the context 22 of the vehicle 10 and a driver context 222 in the driver profile 232, it identifies the filter 212 corresponding to the identified driver context 222.

In some implementations, the filter identifier module 320 identifies the filter 212 of the plurality of filters 212 of the driver profile 232 that corresponds to the action 314 based on the vehicle decision 312 to perform the vehicle action 314. Here, when the vehicle decision module 310 triggers the vehicle decision 312 to perform the vehicle action 314, the filter identifier module 320 is additionally triggered/prompted to identify the filter 212. The filter identifier module 320 may receive the action 314 from the vehicle decision module 310 and, based on the action 314, identify a driving action 206 and its associated filter 212 in the driver profile 232 that corresponds to the action 314.

The personality module 330 is configured to receive the filter 212 output by the filter identifier module 320 and the action 314, and apply the filter 212 of the driver profile 232 to the action 314 to generate an adjusted action 332 that approximates the driving action 206 of the target driver. In other words, the personality module 330 adjusts the action 314 of steering, throttle or braking, to more closely mimic the driving action 206 of the driver profile 232 by applying the filter 212 to the action 314. Thereafter, the safety filtering module 340 receives the adjusted action 332 and any specific tolerances of acceptable vehicle output of the vehicle 10 and applies the tolerances and a safety filter 352 stored in the safety data store 350 to the adjusted action 332 to generate a safety adjusted action 342. Here, if the adjusted action 332 is within the tolerances and safety limits of driving, the safety filtering module 340 may apply a null filter that does not further modify the parameters of the adjusted action 332 to generate the safety adjusted action 342. Thereafter, the driver replication system 300 instructs the vehicle 10 to perform the vehicle decision 312 including the safety adjusted action 342.

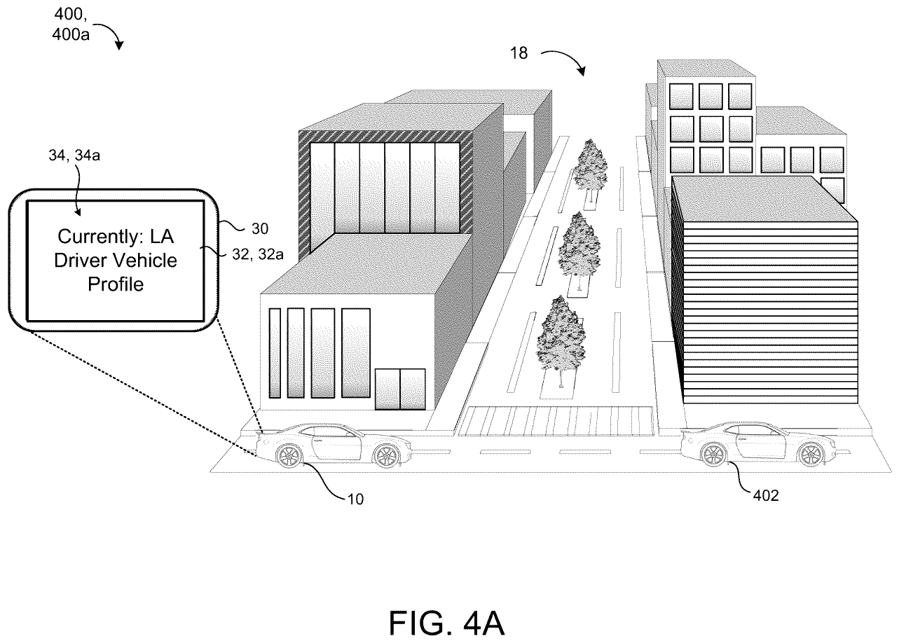

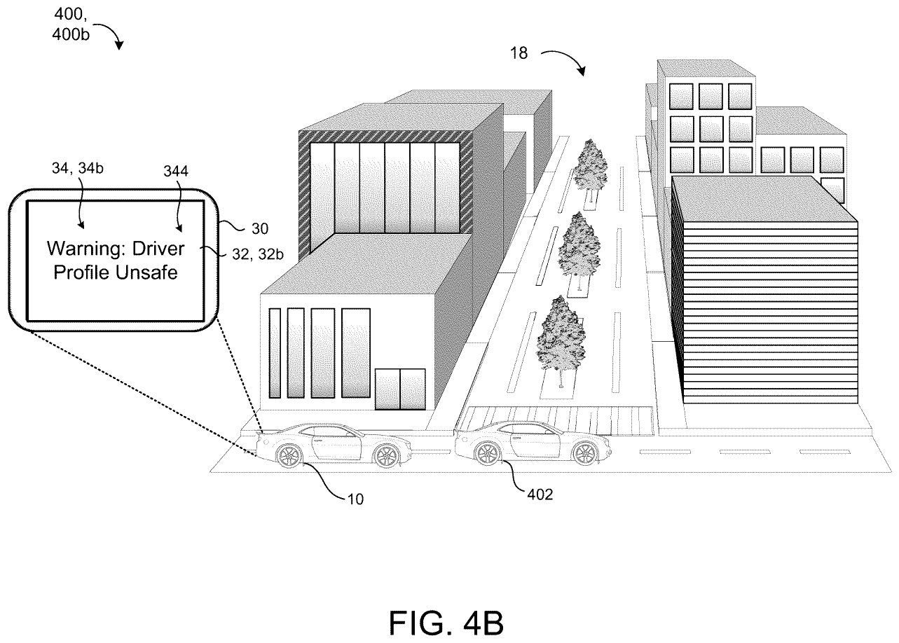

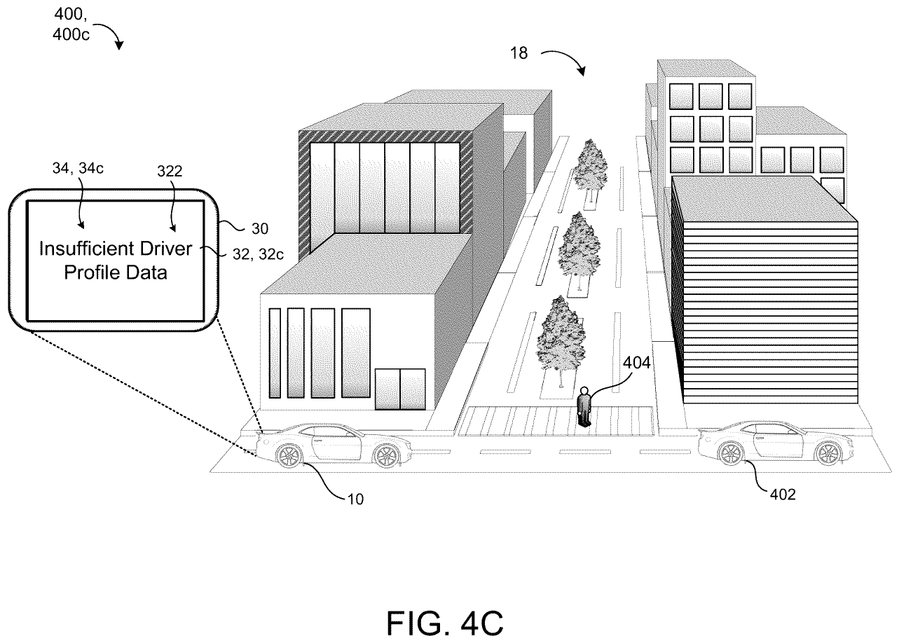

Referring to FIGS. 4A-4C, schematic views 400a-400c show a vehicle 10 executing the driver replication system 300 as the vehicle 10 moves about the environment 18 (e.g., an urban environment 18). Additionally, GUIs 32a-32c rendered on the screen of the user interface 30 in communication with the vehicle 10 are shown to render graphical elements 34 apprising a passenger of the vehicle 10 of a status of the driver replication system 300. As will become apparent as the vehicle 10 moves about the environment 18, the driver replication system 300 will apply various levels of modifications to the standard actions 314 of the vehicle 10.

Referring to FIG. 4A, the vehicle 10 is driving behind a second vehicle 402. As shown, the GUI 32a renders/displays a graphical element 34a “Currently: LA Driver Vehicle Profile” confirming a request 36 by a passenger of the vehicle 10 to initialize a driver profile 232 of a Los Angeles driver (e.g., an aggregate driver profile 232 of LA drivers). For example, the passenger of the vehicle 10 may wish for the vehicle 10 to drive like a local LA driver to increase passenger safety by more closely matching other drivers' following distances, reaction times, etc. Here, the sensor system 16 may detect the sensor data 20 indicating a context 22 that the second vehicle 402 is ahead of the vehicle 10, and that the rest of the road is clear. Moreover, the safety module 340 may determine that, because the vehicle 10 is at a safe distance from the second vehicle 402, that the adjusted action 332 that approximates the driving action 206 of the LA driver does not exceed a safe driving threshold set by the safety filter 352, and apply a null filter to the adjusted action 332.

Referring now to FIG. 4B, the vehicle 10 is still driving behind the second vehicle 402, however the sensor data 20 indicates a context 22 that the following distance of the vehicle 10 is very short. For example, the driver profile 232 of the LA driver may cause the vehicle 10 to start to tailgate the second vehicle 402. Here, when the safety module 340 applies the safety filter 352, it first determines that the adjusted action 332 (i.e., tailgating) exceeds the safe driving threshold set by the safety filter 352 and applies the safety filter 352 to modify the adjusted action 332 to comply with safety regulations. In some implementations, the safety module 340 further generates, for output to a passenger of the vehicle 10, a notification 344 indicating that the driving action 206 of the target driver (i.e., the driver profile 232) exceeds the safe driving threshold. In other words, the notification 344 indicates that the driver profile 232 is not replicated in this instance. As shown in FIG. 4B, the GUI 32b renders/displays a graphical element 34b “Warning: Driver Profile Unsafe” of the notification 344 indicating that the driver profile 232 (i.e., the LA driving action 206) is not being approximated.

Referring to FIG. 4C, the vehicle 10 is preparing to turn left down a side street of the environment 18. Here, the sensor data 20 indicates a context 22 that a pedestrian 404 is in the crosswalk where the vehicle 10 is about to turn. The context 22 that the pedestrian 404 is in the crosswalk triggers the driver replication model 302 to trigger a vehicle decision 312 to perform an action 314. However, the filter identifier module 320 is unable to find a filter 212 of the driver profile 232 that corresponds to the action 314. For example, the driver profile 232 may not have sufficient data to determine a context 222 and associated filter 212 for a pedestrian in a crosswalk. In some implementations, filter identifier module 320 further generates, for output to a passenger of the vehicle 10, a notification 322 indicating that the target driver (i.e., the driver profile 232) does not have a driving action 206 that applies to the context 22. Accordingly, the driver replication system 300 instructs the vehicle 10 to perform the vehicle decision 312 including the vehicle action 314 without modifying the vehicle action 314. Additionally, the GUI 32c renders/displays a graphical element 34c “Insufficient Driver Profile Data” of the notification 322 indicating that the driver profile 232 (i.e., the LA driving action 206) is not being approximated.

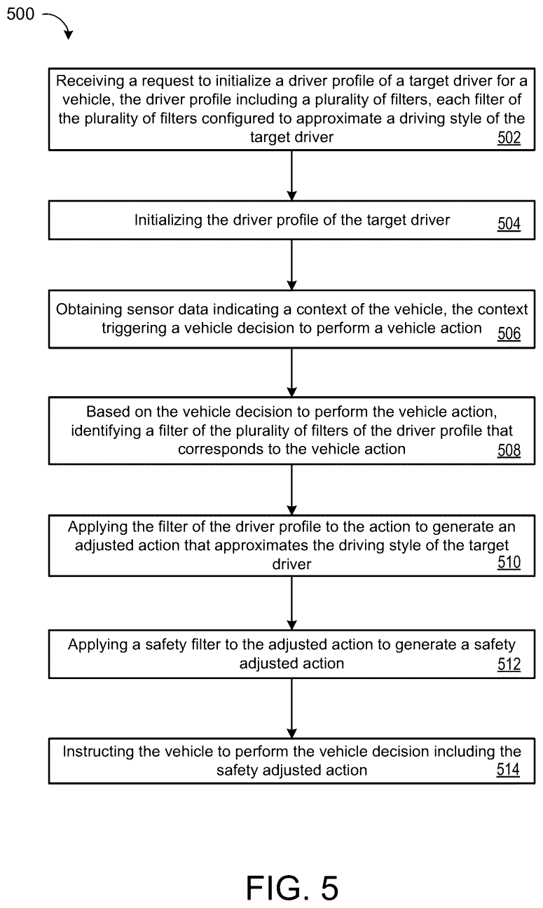

FIG. 5 includes a flowchart of an example arrangement of operations for a method 500 of replicating driver personalities. The method 500 may be described with reference to FIGS. 1-4C. Data processing hardware (e.g., data processing hardware 12, 62 of FIG. 1) may execute instructions stored on memory hardware (e.g., memory hardware 14, 64 of FIG. 1) to perform the example arrangement of operations for the method 500.

At operation 502, the method 500 includes receiving a request 36 to initialize a driver profile 232 of a target driver for a vehicle 10. The driver profile 232 includes a plurality of filters 212, each filter 212 of the plurality of filters 212 are configured to approximate a driving action 206 of the target driver. At operation 504, the method 500 also includes initializing the driver profile 232 of the target driver.

The method 500 also includes, at operation 506, obtaining sensor data 20 indicating a context 22 of the vehicle 10. The context 22 triggers a vehicle decision 312 to perform a vehicle action 314. Based on the vehicle decision 312 to perform the vehicle action 314, the method 500 also includes, at operation 508, identifying a filter 212 of the plurality of filters 212 of the driver profile 232 that corresponds to the vehicle action 314. At operation 510, the method 500 further includes applying the filter 212 of the driver profile 232 to the vehicle action 314 to generate an adjusted action 332 that approximates a driving action 206 of the target driver. The method 500 also includes, at operation 512, applying a safety filter 352 to the adjusted action 332 to generate a safety adjusted action 342. At operation 514, the method 500 further includes instructing the vehicle 10 to perform the vehicle decision 312 including the safety adjusted action 342.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed on data processing hardware causes the data processing hardware to perform operations comprising:
receiving a request to initialize a driver profile of a target driver for a vehicle, the driver profile including a plurality of filters, each filter of the plurality of filters configured to approximate a driving action of the target driver;
initializing the driver profile of the target driver;
obtaining sensor data indicating a context of the vehicle, the context triggering a vehicle decision to perform a vehicle action;
based on the vehicle decision to perform the vehicle action, identifying a filter of the plurality of filters of the driver profile that corresponds to the vehicle action;
applying the filter of the driver profile to the action to generate an adjusted action that approximates the driving style of the target driver;
applying a safety filter to the adjusted action to generate a safety adjusted action; and
instructing the vehicle to perform the vehicle decision including the safety adjusted action.

2. The method of claim 1, wherein the driver profile is stored in a corpus of driver profiles.

3. The method of claim 2, wherein the corpus of driver profiles comprises one or more aggregate driver profiles each approximating a demographic driving style.

4. The method of claim 2, wherein the operations further comprise:
receiving driving data, the driving data including a plurality of driving actions;
for each driving action of the plurality of driving actions:
deriving a filter from the driving action; and
associating one or more of vehicle parameters, vehicle environment, or vehicle positioning with the derived filter;
generating a new driver profile including the plurality of derived filters; and
storing the new driver profile in the corpus of driver profiles.

5. The method of claim 4, wherein the plurality of driving actions includes one or more of steering, throttle, or braking.

6. The method of claim 1, wherein each filter of the plurality of filters is associated with a set of driving actions of the target driver.

7. The method of claim 1, wherein identifying the filter of the plurality of filters of the driver profile that corresponds to the action is based on a driver context associated with the filter, the driver context corresponding to the context of the vehicle.

8. The method of claim 1, wherein applying the safety filter to the adjusted action to generate the safety adjusted action comprises:
determining that the adjusted action that approximates the driving style of the target driver exceeds a safe driving threshold; and
generating, for output to a passenger of the vehicle, a notification indicating that that the driving style of the target driver exceeds the safe driving threshold.

9. The method of claim 1, wherein applying the safety filter to the adjusted action to generate the safety adjusted action comprises:
determining that the adjusted action that approximates the driving style of the target driver does not exceed a safe driving threshold; and
applying a null filter to the adjusted action.

10. The method of claim 1, wherein the operations further comprise:
obtaining additional sensor data indicating a subsequent context of the vehicle, the subsequent context triggering a subsequent vehicle decision to perform an additional vehicle action;
determining that the plurality of filters of the driver profile does not include a filter that corresponds to the subsequent vehicle action; and
instructing the vehicle to perform the subsequent vehicle decision without modifying the subsequent vehicle action.

11. A system comprising:
data processing hardware; and
memory hardware in communication with the data processing hardware, the memory hardware storing instructions that when executed on the data processing hardware cause the data processing hardware to perform operations comprising:
receiving a request to initialize a driver profile of a target driver for a vehicle, the driver profile including a plurality of filters, each filter of the plurality of filters configured to approximate a driving action of the target driver;
initializing the driver profile of the target driver;
obtaining sensor data indicating a context of the vehicle, the context triggering a vehicle decision to perform a vehicle action;
based on the vehicle decision to perform the vehicle action, identifying a filter of the plurality of filters of the driver profile that corresponds to the vehicle action;
applying the filter of the driver profile to the vehicle action to generate an adjusted action that approximates the driving style of the target driver;
applying a safety filter to the adjusted action to generate a safety adjusted action; and
instructing the vehicle to perform the vehicle decision including the safety adjusted action.

12. The system of claim 11, wherein the driver profile is stored in a corpus of driver profiles.

13. The system of claim 12, wherein the corpus of driver profiles comprises one or more aggregate driver profiles each approximating a demographic driving style.

14. The system of claim 12, wherein the operations further comprise:
receiving driving data, the driving data including a plurality of driving actions;
for each driving action of the plurality of driving actions:
deriving a filter from the driving action; and
associating one or more of vehicle parameters, vehicle environment, or vehicle positioning with the derived filter;
generating a new driver profile including the plurality of derived filters; and
storing the new driver profile in the corpus of driver profiles.

15. The system of claim 14, wherein the plurality of driving actions includes one or more of steering, throttle, or braking.

16. The system of claim 11, wherein each filter of the plurality of filters is associated with a set of driving actions of the target driver.

17. The system of claim 11, wherein identifying the filter of the plurality of filters of the driver profile that corresponds to the vehicle action is based on a driver context associated with the filter, the driver context corresponding to the context of the vehicle.

18. The system of claim 11, wherein applying the safety filter to the adjusted action to generate the safety adjusted action comprises:
determining that the adjusted action that approximates the driving style of the target driver exceeds a safe driving threshold; and
generating, for output to a passenger of the vehicle, a notification indicating that that the driving style of the target driver exceeds the safe driving threshold.

19. The system of claim 11, wherein applying the safety filter to the adjusted action to generate the safety adjusted action comprises:
determining that the adjusted action that approximates the driving style of the target driver does not exceed a safe driving threshold; and
applying a null filter to the adjusted action.

20. The system of claim 11, wherein the operations further comprise:
obtaining additional sensor data indicating a subsequent context of the vehicle, the subsequent context triggering a subsequent vehicle decision to perform an additional vehicle action;
determining that the plurality of filters of the driver profile do not include a filter that corresponds to the subsequent vehicle action; and
instructing the vehicle to perform the subsequent vehicle decision without modifying the subsequent vehicle action.
